(19) United States
(12) Patent Application Publication
(10) Pub. No.: US 2015/0229142 A1
(43) Pub. Date: Aug. 13, 2015

(54) BATTERY CONTROL DEVICE, ELECTRIC STORAGE DEVICE, METHOD FOR OPERATING ELECTRIC STORAGE DEVICE, AND PROGRAM

(71) Applicant: NEC Corporation, Tokyo (JP)

(72) Inventors: Shingo Takahashi, Tokyo (JP); Koji Matsunaga, Tokyo (JP); Nobuhide Yoshida, Tokyo (JP); Noriyuki Itabashi, Tokyo (JP); Yuan Luo, Tokyo (JP)

(21) Appl. No.: 14/422,269

(22) PCT Filed: Jul. 19, 2013
(86) PCT No.: PCT/JP2013/069591

§ 371 Date: Feb. 18, 2015

(30) Foreign Application Priority Data
Aug. 22, 2012 (JP) 2012-182930

(51) Int. Cl. H02J 7/00

(52) U.S. Cl. CPC H02J 7/0021

(57) ABSTRACT

Secondary battery cells (100) are connected in series. A measurement unit (120) measures the sum of the voltages of the plurality of secondary battery cells (100). A balance circuit (140) equalizes the voltages of the plurality of secondary battery cells (100). A control unit (160) controls the balance circuit (140). Specifically, the control unit (160) operates the balance circuit (140) when the charging rate of the plurality of secondary battery cells (100) is equal to or less than 50% or the sum of the voltages of the plurality of secondary battery cells (100) is equal to or less than a first reference value and an absolute value of a differential value of a graph indicating the sum of the voltages when the charging rate is a variable is equal to or less than a second reference value.

### TECHNICAL FIELD

The present invention relates to a battery control device that controls the charging of batteries formed of a plurality of secondary battery cells connected in series, an electric storage device, a method for operating an electric storage device, and a program.

### BACKGROUND ART

In recent years, secondary batteries, such as lithium ion batteries, have been used in various fields in order to reduce an environmental load. In many cases, a plurality of secondary batteries are used while being connected in series, in order to obtain a target voltage (for example, a commercial voltage). However, as the plurality of secondary batteries which are connected in series are used, the degrees of deterioration of the secondary batteries become different from each other due to the individual differences between the secondary batteries. When the degrees of deterioration of the secondary batteries are different from each other, the full charge capacities of the secondary batteries are different from each other. Therefore, a process (balance control) for equalizing the charge capacities of the plurality of secondary batteries is performed. In general, balance control is performed when the secondary batteries are fully charged.

Patent Document 1 discloses a technique for performing balance control immediately before charging starts.

### RELATED DOCUMENT

### Patent Document

[Patent Document 1] Japanese Unexamined Patent Publication No. 2010-57249

### DISCLOSURE OF THE INVENTION

As described above, in many cases, the secondary batteries are used while being connected in series. In many cases, the secondary batteries which are used in this state are controlled such that the degrees of deterioration of the secondary batteries are equalized. However, the inventors considered that a technique for intentionally making the degrees of deterioration of a plurality of secondary batteries different from each other and sequentially replacing the secondary batteries from the deteriorated secondary battery was effective in terms of costs.

The inventors considered that it was possible to make the degrees of deterioration of a plurality of secondary batteries different from each other by equalizing the voltages between the plurality of secondary batteries when charging started. In addition, the inventors considered that, when balance control was performed immediately before charging started as disclosed in Patent Document 1, time is required until charging started.

An object of the invention is to provide a battery control device, an electric storage device, a method for operating an electric storage device, and a program that can suppress deterioration of the secondary batteries of an electric storage device and shorten the time until charging starts.

According to the invention, there is provided a battery control device that controls an electric storage device including a plurality of secondary battery cells which are connected in series, a measurement unit which measures the sum of voltages of the plurality of secondary battery cells, and a balancing unit which equalizes the voltages of the plurality of secondary battery cells. The battery control device operates the balancing unit when a charging rate of the plurality of secondary battery cells is equal to or less than 50% or the sum of the voltages is equal to or less than a first reference value and an absolute value of a differential value of the sum of the voltages when the charging rate is a variable is equal to or less than a second reference value.

According to the invention, there is provided a battery control device that controls an electric storage device including a plurality of secondary battery cells which are connected in series, a measurement unit which measures the sum of voltages of the plurality of secondary battery cells, and a balancing unit which equalizes the voltages of the plurality of secondary battery cells. The battery control device operates the balancing unit when the sum of the voltages of the plurality of secondary battery cells is equal to or less than the first reference value at least while the plurality of secondary battery cells are being discharged or charged.

According to the invention, there is provided an electric storage device including: a plurality of secondary battery cells which are connected in series; a measurement unit which measures the sum of voltages of the plurality of secondary battery cells; a balancing unit which equalizes the voltages of the plurality of secondary battery cells; and a control unit which controls the balancing unit. The control unit operates the balancing unit when a charging rate of the plurality of secondary battery cells is equal to or less than 50% or the sum of the voltages is equal to or less than a first reference value and a differential value of a graph indicating the sum of the voltages when the charging rate is a variable is equal to or less than a second reference value.

According to the invention, there is provided an electric storage device including: a plurality of secondary battery cells which are connected in series; a measurement unit which measures the sum of voltages of the plurality of secondary battery cells; a balancing unit which equalizes the voltages of the plurality of secondary battery cells; and a control unit which controls the balancing unit. The control unit operates the balancing unit when the sum of the voltages of the plurality of secondary battery cells is equal to or less than the first reference value at least while the plurality of secondary battery cells are being discharged or charged.

According to the invention, there is provided a method for operating an electric storage device including: preparing an electric storage device including a plurality of secondary battery cells which are connected in series, a measurement unit which measures the sum of voltages of the plurality of secondary battery cells, and a balancing unit which equalizes the voltages of the plurality of secondary battery cells; and operating the balancing unit when a charging rate of the plurality of secondary battery cells is equal to or less than 50% or the sum of the voltages is equal to or less than a first reference value and a differential value of a graph indicating the sum of the voltages when the charging rate is a variable is equal to or less than a second reference value.

According to the invention, there is provided a method for operating an electric storage device including: preparing an electric storage device including a plurality of secondary battery cells which are connected in series, a measurement unit which measures the sum of voltages of the plurality of secondary battery cells, and a balancing unit which equalizes the voltages of the plurality of secondary battery cells; and operating the balancing unit when the sum of the voltages of the plurality of secondary battery cells is equal to or less than the first reference value at least while the plurality of secondary battery cells are being discharged or charged.

According to the invention, there is provided a program for controlling an electric storage device including a plurality of secondary battery cells which are connected in series, a measurement unit which measures the sum of voltages of the plurality of secondary battery cells, and a balancing unit which equalizes the voltages of the plurality of secondary battery cells. The program causes a computer to have the functions of: operating the balancing unit when a charging rate of the plurality of secondary battery cells is equal to or less than 50% or the sum of the voltages is equal to or less than a first reference value and a differential value of a graph indicating the sum of the voltages when the charging rate is a variable is equal to or less than a second reference value.

According to the invention, there is provided a program for controlling an electric storage device including a plurality of secondary battery cells which are connected in series, a measurement unit which measures the sum of voltages of the plurality of secondary battery cells, and a balancing unit which equalizes the voltages of the plurality of secondary battery cells. The program causes a computer to have the functions of: operating the balancing unit when the sum of the voltages of the plurality of secondary battery cells is equal to or less than the first reference value at least while the plurality of secondary battery cells are being discharged or charged.

According to the invention, it is possible to suppress deterioration of the secondary batteries of an electric storage device and shorten the time until charging starts.

### BRIEF DESCRIPTION OF THE DRAWINGS

The above and other objects, features, and advantages will become more readily apparent from the following preferred embodiments and the following accompanying drawings.

FIG. 1 is a diagram illustrating the structure of an electric storage device according to a first embodiment.

FIG. 2 is a flowchart illustrating a first example of a control process performed by a control unit.

FIG. 3 is a graph illustrating the sum of the voltages of secondary battery cells when a charging rate is a variable.

FIG. 4 is a flowchart illustrating a second example of the control process performed by the control unit.

FIG. 5 is a flowchart illustrating the operation of the electric storage device and a charge control device.

FIG. 6 is a diagram illustrating the relationship between the voltage of the secondary battery cell and the timing at which a balancing process is performed.

FIG. 7 is a diagram schematically illustrating how the secondary battery cell is charged.

FIG. 8 is a diagram illustrating a method for charging a plurality of secondary battery cells using a method according to a comparative example.

FIG. 9 is a flowchart illustrating the operation of a control unit according to a second embodiment.

### DESCRIPTION OF EMBODIMENTS

Hereinafter, embodiments of the invention will be described with reference to the drawings. However, in all of the drawings, the same components are denoted by the same reference numerals and the description thereof will not be repeated.

### First Embodiment

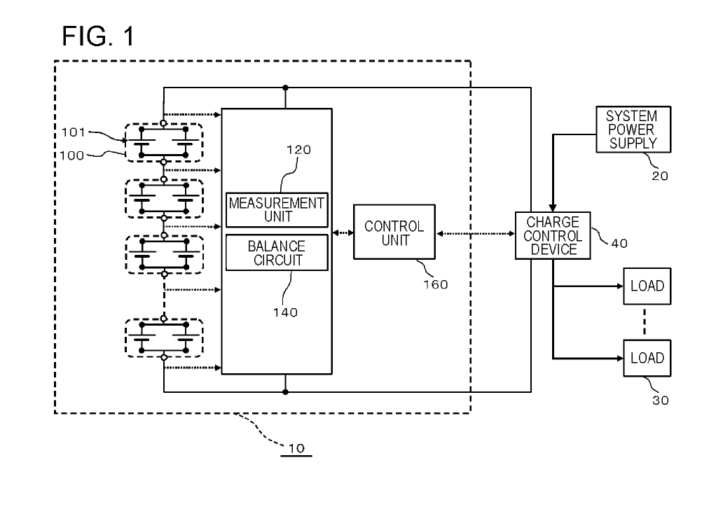

FIG. 1 is a diagram illustrating the structure of an electric storage device 10 according to a first embodiment. The electric storage device 10 includes a control unit 160 (electric storage control device). The electric storage device 10 includes a plurality of secondary battery cells 100, a measurement unit 120, and a balance circuit 140 (balancing unit), in addition to the control unit 160. The secondary battery cells 100 are connected in series. The measurement unit 120 measures the sum of the voltages of the plurality of secondary battery cells 100. The balance circuit 140 equalizes the voltages of the plurality of secondary battery cells 100. The control unit 160 controls the balance circuit 140. Specifically, the control unit 160 operates the balance circuit 140 when the charging rate of the plurality of secondary battery cells 100 is equal to or less than 50% or the sum of the voltages of the secondary battery cells 100 is equal to or less than a first reference value and the absolute value of the differential value of a graph indicating the sum of the voltages when the charging rate is a variable is equal to or less than a second reference value.

In this embodiment, since the balance circuit 140 is operated under the above-mentioned conditions, it is possible to equalize the voltages of the plurality of secondary battery cells 100 before charging starts. After charging is completed, the balance circuit 140 is not operated. According to this structure, when the charging of the plurality of secondary battery cells 100 is completed, the charging rate (charge level/full charge capacity) of the secondary battery cell 100 whose deterioration is not in progress is lower than the charging rate of the secondary battery cell 100 whose deterioration is in progress. Therefore, the deterioration of the secondary battery cell 100 whose deterioration is not in progress is further delayed. As a result, it is possible to suppress the deterioration of the secondary battery cell 100. It is possible to intentionally make the degrees of deterioration of the plurality of secondary battery cells 100 different from each other. Since balance control is performed during discharge, it is possible to suppress an increase in the period from the time at which the voltage reaches a charge start voltage to the time at which charging starts due to the balance control. Therefore, it is possible to shorten the time until charging starts. This embodiment will be described in detail below.

In this embodiment, the secondary battery cell 100 includes a plurality of secondary batteries 101 which are connected in parallel. The secondary battery 101 is, for example, a lithium-ion battery.

The measurement unit 120 measures the voltage between a positive terminal of the secondary battery cell 100 which is closest to a positive electrode and a negative terminal of the secondary battery cell 100 which is closest to a negative electrode in order to measure the sum of the voltages of the plurality of secondary battery cells 100. However, the measurement unit 120 may measure the voltage of each of the plurality of secondary battery cells 100 and add the measurement results in order to calculate the sum of the voltages of the plurality of secondary battery cells 100. In addition, the measurement unit 120 may measure a current which flows to the secondary battery cells 100. The measurement unit 120 outputs the measurement result to the control unit 160.

The balance circuit 140 equalizes the voltages of the plurality of secondary battery cells 100 using a passive method, such as a resistor method. The passive method discharges the power of the secondary battery cell 100 with a relatively high voltage so as to equalize the voltages of the plurality of secondary battery cells 100. However, the balance circuit 140 may equalize the voltages of the plurality of secondary battery cells 100 using an active method, such as a transformer method or a capacitor method. The active method transfers the power of the secondary battery cell 100 with a relatively high voltage to the secondary battery cell 100 with a relatively low voltage to equalize the voltages of the plurality of secondary battery cells 100.

A positive terminal of the electric storage device 10 (that is, the positive terminal of the secondary battery cell 100 closest to the positive electrode) is connected to a positive terminal of the charge control device 40. A negative terminal of the electric storage device 10 (the negative terminal of the secondary battery cell 100 closest to the negative electrode) is connected to a negative terminal of the charge control device 40. The charge control device 40 connects a system power supply 20 and a plurality of loads 30 to the electric storage device 10. That is, the charge control device 40 supplies power which is supplied from the system power supply 20 to the electric storage device 10 in order to charge the plurality of secondary battery cells 100, if necessary. In addition, the charge control device 40 supplies the power of the plurality of secondary battery cells 100 to the load 30, if necessary. The charge control device 40 receives the measurement result of the measurement unit 120 from the control unit 160.

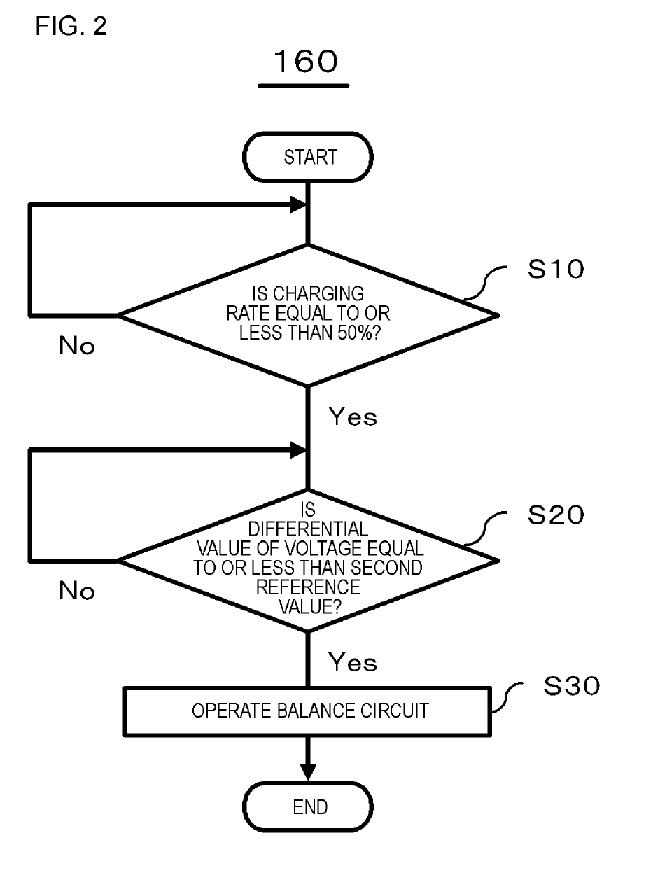

FIG. 2 is a flowchart illustrating a first example of a control process performed by the control unit 160. In the following process flow, the measurement unit 120 measures (or calculates) the sum of the voltages of the plurality of secondary battery cells 100 and outputs the measurement result to the control unit 160.

First, the control unit 160 determines whether the charging rate of the plurality of secondary battery cells 100 is equal to or less than 50% (Step S10). The charging rate of the plurality of secondary battery cells 100 is calculated on the basis of, for example, the sum of the voltages of the plurality of secondary battery cells 100. For example, the control unit 160 stores data indicating the relationship between the charging rate and the voltage and calculates the charging rate on the basis of the data.

If the charging rate of the plurality of secondary battery cells 100 is equal to or less than the first reference value (Step S10: Yes), the control unit 160 calculates the differential value of the sum of the voltages of the plurality of secondary battery cells 100 when the charging rate is a variable and determines whether the absolute value of the calculated value is equal to or greater than the second reference value (Step S20). This process is performed using the data which is being measured. When the absolute value of the calculated value is equal to or greater than the second reference value (Step S20: Yes), the control unit 160 operates the balance circuit 140 (Step S30).

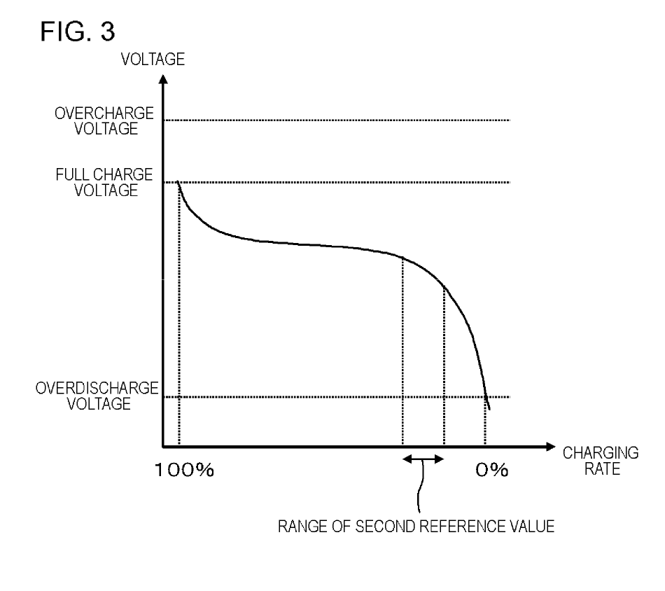

FIG. 3 is a graph illustrating the sum of the voltages of the secondary battery cells 100 when the charging rate is a variable. As illustrated in FIG. 3, the voltage is suddenly changed in the vicinity of a charging rate of 100%, with a reduction in the charging rate. Then, the voltage is not greatly changed when the charging rate is less than 50%. However, the voltage is suddenly changed in the vicinity of a charging rate of 0%, with a reduction in the charging rate. Therefore, even when the balance circuit 140 is operated in a region in which the charging rate is close to 0%, it is difficult to restore the operation of the balance circuit 140 to its normal state. In contrast, in the this embodiment, the balance circuit 140 is operated when the charging rate is equal to or less than 50% and the absolute value of the differential value of the charging rate in the graph illustrated in FIG. 3 is equal to or less than the second reference value. Therefore, by setting the second reference value to a value in an appropriate range, it is possible to easily restore the operation of the balance circuit 140 to its normal state. When the secondary battery cell 100 is a lithium-ion battery, the second reference value is, for example, equal to or greater than 0.015 and equal to or less than 0.019.

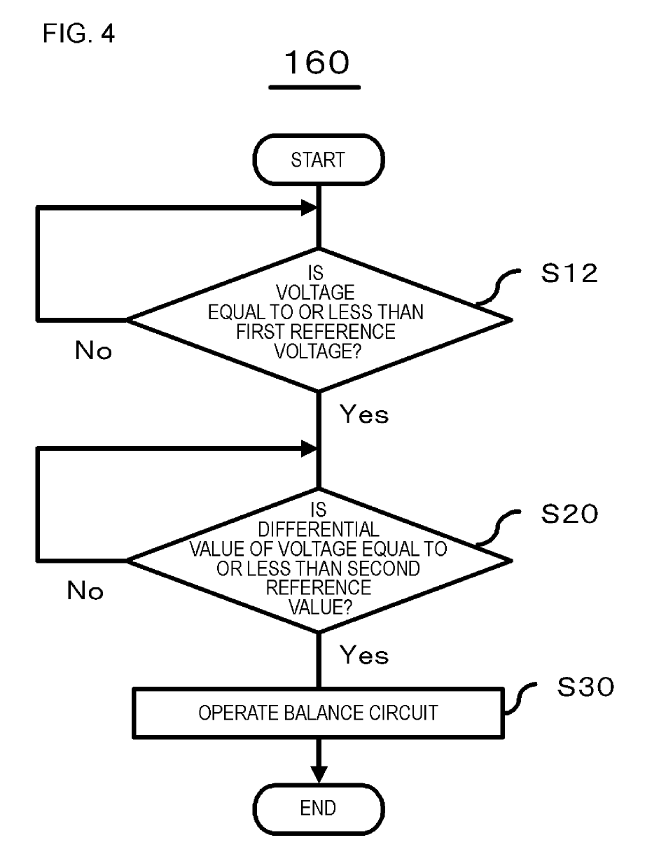

FIG. 4 is a flowchart illustrating a second example of the control process performed by the control unit 160. In the following process flow, the measurement unit 120 measures the sum of the voltages of the plurality of secondary battery cells 100 and outputs the measurement result to the control unit 160.

First, the control unit 160 determines whether the sum of the voltages of the plurality of secondary battery cells 100 is equal to or less than the first reference value (Step S12). When the sum of the voltages of the plurality of secondary battery cells 100 is equal to or less than the first reference value, the charging rate of the plurality of secondary battery cells 100 is equal to or less than a reference value (for example, 50%). When the secondary battery cell 100 is a lithium-ion battery, the first reference value is, for example, equal to or greater than 3.4 V and equal to or less than 3.6 V.

If the voltages of the plurality of secondary battery cells 100 are equal to or less than the first reference value (Step S12: Yes), the control unit 160 calculates the differential value of the sum of the voltages of the plurality of secondary battery cells 100 when the charging rate is a variable and determines whether the absolute value of the calculated value is equal to or greater than the second reference value (Step S20). When the absolute value of the calculated value is equal to or greater than the second reference value (Step S20: Yes), the control unit 160 operates the balance circuit 140 (Step S30). Step S20 and Step S30 are the same as those in the first example illustrated in FIG. 2.

The operation of the balance circuit 140 is performed at least while the electric storage device 10 is being discharged or charged.

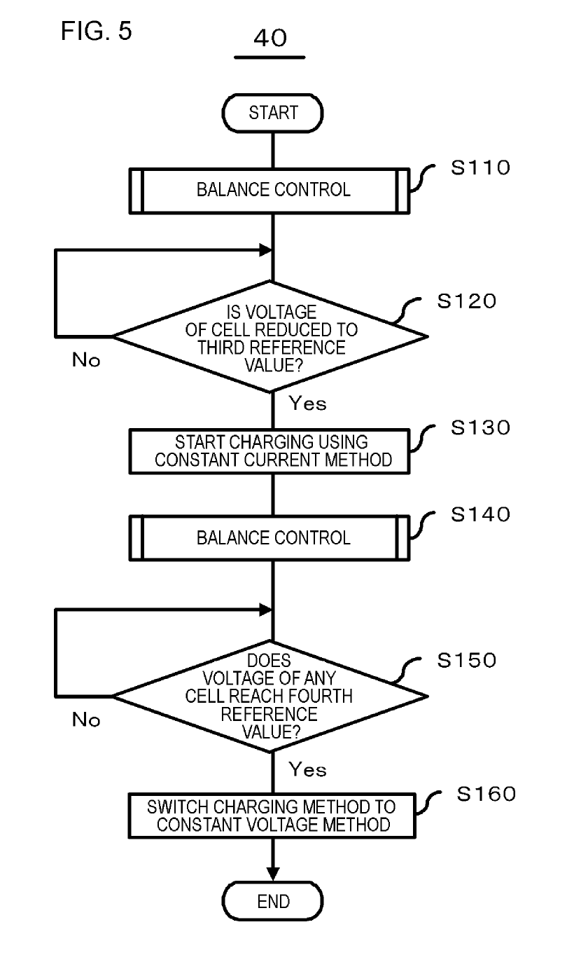

FIG. 5 is a flowchart illustrating the operation of the electric storage device 10 and the charge control device 40. First, the charge control device 40 supplies power from the electric storage device 10 to the load 30, if necessary. When discharge progresses, the control unit 160 of the electric storage device 10 operates the balance circuit 140, if necessary (Step S110). The details of this process are the same as those described with reference to FIGS. 2 to 4.

Then, when the voltage of the secondary battery cells 100 is reduced to a third reference voltage (charge start voltage) (Step S120: Yes), the charge control device 40 starts to charge the plurality of secondary battery cells 100 using a constant current method (Step S130).

During charging, the control unit 160 of the electric storage device 10 operates the balance circuit 140 according to the process illustrated in FIG. 2 or FIG. 4 (Step S140). Then, when the voltage of any one of the secondary battery cells 100 reaches a fourth reference value (Step S150: Yes), the charge control device 40 switches the charging method for the secondary battery cells 100 from the constant current method to a constant voltage method (Step S160). Then, for example, after a reference period of time has elapsed or when the current which flows through the secondary battery cell 100 is equal to or less than a reference value, the charge control device 40 ends the process of charging the plurality of secondary battery cells 100.

When the secondary battery cell 100 is a lithium-ion battery, the difference in voltage between the secondary battery cell 100 with the highest voltage and the secondary battery cell 100 with the lowest voltage among the plurality of secondary battery cells 100 which have been completely charged is equal to or greater than 0.1 V and equal to or less than 0.5 V, for example, equal to or greater than 0.3V and equal to or less than 0.5 V.

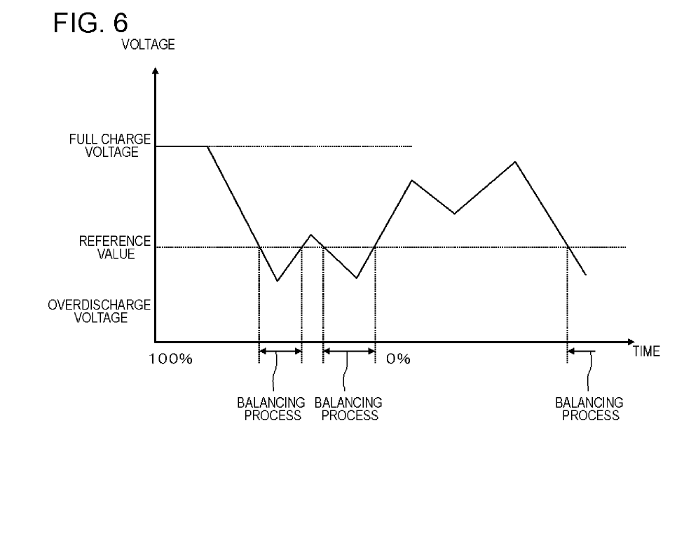

FIG. 6 is a diagram illustrating the relationship between the voltage of the secondary battery cell 100 and the timing at which a balancing process is performed. As described above, the control unit 160 operates the balance circuit 140 when the charging rate of the plurality of secondary battery cells 100 is equal to or less than 50% or the sum of the voltages is equal to or less than the first reference value and the absolute value of the differential value of the sum of the voltages when the charging rate is a variable is equal to or less than the second reference value. When this is schematically shown, as illustrated in FIG. 6, the balance circuit 140 is operated at any timing, regardless of whether the secondary battery cell is being charged or discharged, when the voltage of the secondary battery cell 100 is equal to or less than a reference value.

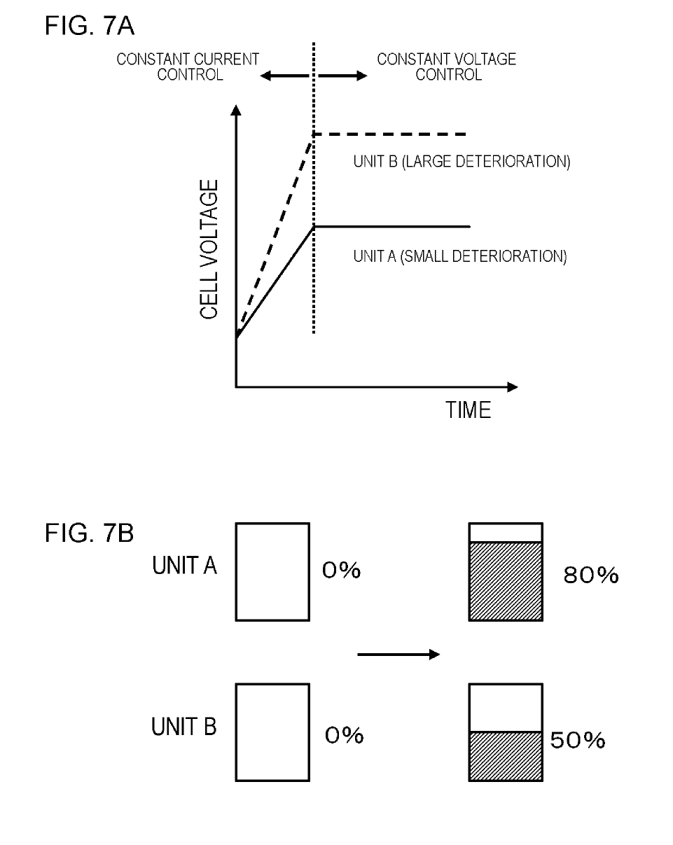

FIG. 7 is a diagram schematically illustrating how the secondary battery cell 100 is charged. There is a difference in the progress of deterioration between the secondary battery cells 100 due to the individual differences between the secondary battery cells 100. Therefore, as illustrated in FIG. 7(a), when the secondary battery cells 100 are charged by the constant current method, the voltage of the secondary battery cell 100 (unit A) which is relatively deteriorated increases rapidly as compared to the secondary battery cell 100 (unit B) which is not relatively deteriorated. When the sum of the voltages reaches the fourth reference voltage, the charging method is switched to the constant voltage method.

As a result, as illustrated in FIG. 7(b), the charging rate of the secondary battery cell 100 (unit A) which is relatively deteriorated is higher than the charging rate of the secondary battery cell 100 (unit B) which is not relatively deteriorated. The deterioration speed of the secondary battery 101 forming the secondary battery cell 100 increases as the charging rate increases. The progress of the deterioration of the secondary battery cell 100 (unit B) whose deterioration is not progressed is further delayed. Therefore, it is possible to intentionally make the degrees of deterioration of the plurality of secondary battery cells 100 different from each other. As a result, it is possible to sequentially replace the secondary battery cells 100 in order from the secondary battery cell 100 which has deteriorated. Therefore, it is possible to reduce the maintenance costs of the electric storage device 10.

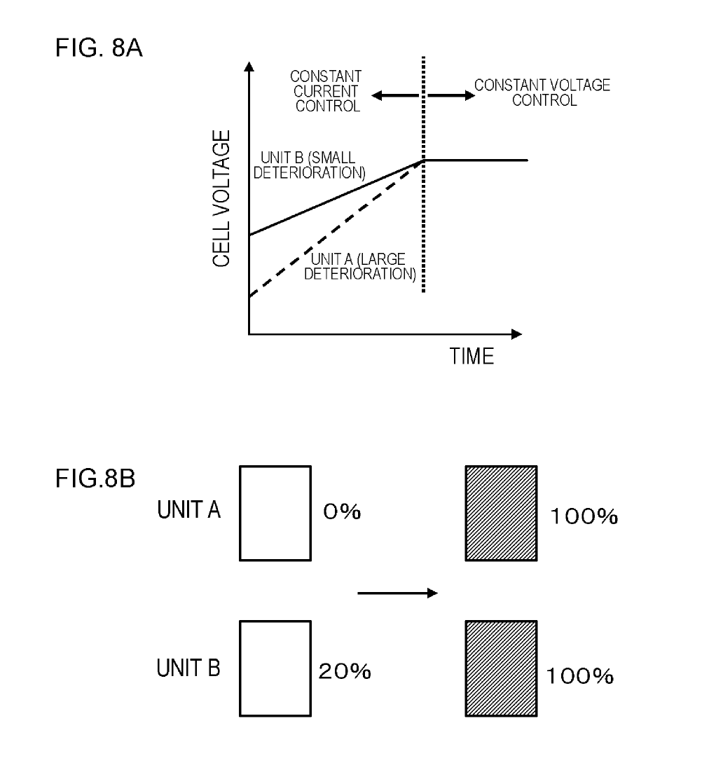

FIG. 8 is a diagram illustrating a method for charging the plurality of secondary battery cells 100 using a method according to a comparative example. In the comparative example, the charge control device 40 performs charging using the constant current method until each of the plurality of secondary battery cells 100 reaches a full charge voltage, and performs charging using the constant voltage method after each secondary battery cell reaches the full charge voltage. In this method, the balance circuit 140 equalizes the voltages of the plurality of secondary battery cells 100 after the plurality of secondary battery cells 100 are charged.

In this method, the charging rate of both the secondary battery cell 100 (unit A) which is relatively deteriorated and the secondary battery cell 100 (unit B) which is not relatively deteriorated is 100%. In this case, the secondary battery cell 100 (unit B) whose deterioration is not in progress starts to deteriorate.

As described above, according to this embodiment, the control unit 160 operates the balance circuit 140 when the charging rate of the plurality of secondary battery cells 100 is equal to or less than 50% or the sum of the voltages of the secondary battery cells 100 is equal to or less than the first reference value and the absolute value of the differential value of the graph indicating the sum of the voltages when the charging rate is a variable is equal to or greater than the second reference value. Therefore, it is possible to equalize the voltages of the plurality of secondary battery cells 100 before charging starts. As a result, it is possible to intentionally make the degrees of deterioration of the plurality of secondary battery cells 100 different from each other. In addition, since the balance control is performed during discharge, it is possible to suppress an increase in the period of time from when the voltage reaches the charge start voltage to when charging starts due to the balance control. Therefore, it is possible to shorten the time until charging starts.

### Second Embodiment

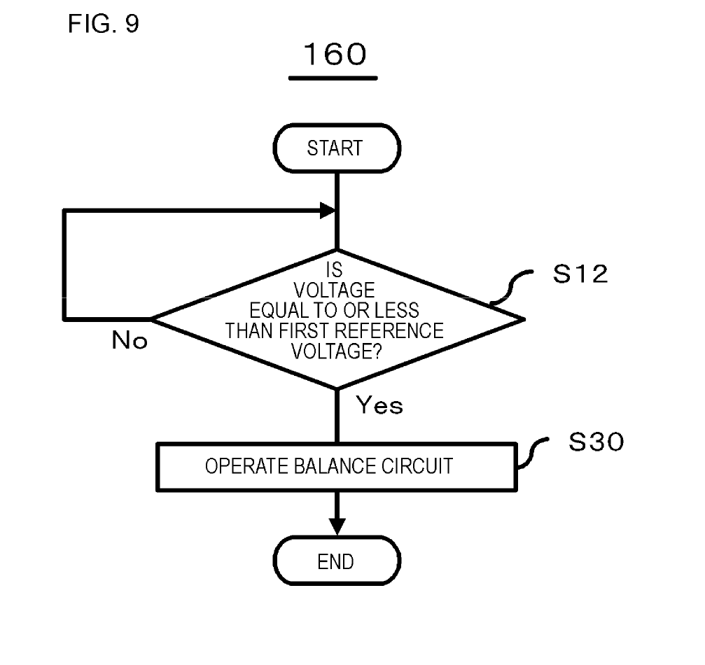

FIG. 9 is a flowchart illustrating the operation of a control unit 160 according to a second embodiment. An electric storage device 10 according to this embodiment has the same structure as the electric storage device 10 according to the first embodiment except for the operation of the control unit 160.

In this embodiment, when the sum of the voltages of a plurality of secondary battery cells 100 is equal to or less than a first reference value (Step S12: Yes), the control unit 160 operates a balance circuit 140 (Step S30). The determination illustrated in FIG. 9 is performed during both charge and discharge, as illustrated in FIG. 5 in the first embodiment. When the secondary battery cell 100 is a lithium-ion battery, the first reference value is equal to or greater than 3.4 V and equal to or less than 3.6 V.

In this embodiment, it is possible to obtain the same effect as that in the first embodiment.

The embodiments of the invention have been described above with reference to the drawings. However, the above-described embodiments are illustrative examples of the invention and various structures other than the above-mentioned structures can be used.

The above-described embodiments disclose the following structures.

### Appendix 1

There is provided a battery control device that controls an electric storage device including a plurality of secondary battery cells which are connected in series, a measurement unit which measures the sum of voltages of the plurality of secondary battery cells, and a balancing unit which equalizes the voltages of the plurality of secondary battery cells. The battery control device operates the balancing unit when a charging rate of the plurality of secondary battery cells is equal to or less than 50% or the sum of the voltages is equal to or less than a first reference value and an absolute value of a differential value of the sum of the voltages when the charging rate is a variable is equal to or less than a second reference value.

### Appendix 2

In the battery control device according to Appendix 1, the battery control device operates the balancing unit at least while the plurality of secondary battery cells are being discharged or charged.

### Appendix 3

In the battery control device according to Appendix 1 or 2, the plurality of secondary battery cells are lithium-ion batteries and the second reference value is equal to or greater than 0.015 and equal to or less than 0.019.

### Appendix 4

In the battery control device according to Appendix 1 or 2, the plurality of secondary battery cells is lithium-ion batteries. The battery control device operates the balancing unit when the sum of the voltages is equal to or less than the first reference value. The first reference value is equal to or greater than 3.4 V and equal to or less than 3.6 V.

### Appendix 5

There is provided a battery control device that controls an electric storage device including a plurality of secondary battery cells which are connected in series, a measurement unit which measures the sum of voltages of the plurality of secondary battery cells, and a balancing unit which equalizes the voltages of the plurality of secondary battery cells. The battery control device operates the balancing unit when the sum of the voltages of the plurality of secondary battery cells is equal to or less than the first reference value at least while the plurality of secondary battery cells are being discharged or charged.

### Appendix 6

In the battery control device according to Appendix 5, the plurality of secondary battery cells are lithium-ion batteries and the first reference value is equal to or greater than 3.4 V and equal to or less than 3.6 V.

### Appendix 7

There is provided an electric storage device including: a plurality of secondary battery cells which are connected in series; a measurement unit which measures the sum of voltages of the plurality of secondary battery cells; a balancing unit which equalizes the voltages of the plurality of secondary battery cells; and a control unit which controls the balancing unit. The control unit operates the balancing unit when a charging rate of the plurality of secondary battery cells is equal to or less than 50% or the sum of the voltages is equal to or less than a first reference value and a differential value of a graph indicating the sum of the voltages when the charging rate is a variable is equal to or less than a second reference value.

### Appendix 8

In the electric storage device according to Appendix 7, the control unit operates the balancing unit at least while the plurality of secondary battery cells are being discharged or charged.

### Appendix 9

In the electric storage device according to Appendix 7 or 8, the plurality of secondary battery cells are lithium-ion batteries and the second reference value is equal to or greater than 0.015 and equal to or less than 0.019.

### Appendix 10

In the electric storage device according to Appendix 7 or 8, the plurality of secondary battery cells is lithium-ion batteries. The control unit operates the balancing unit when the sum of the voltages is equal to or less than the first reference value. The first reference value is equal to or greater than 3.4 V and equal to or less than 3.6 V.

### Appendix 11

There is provided an electric storage device including: a plurality of secondary battery cells which are connected in series; a measurement unit which measures the sum of voltages of the plurality of secondary battery cells; a balancing unit which equalizes the voltages of the plurality of secondary battery cells; and a control unit which controls the balancing unit. The control unit operates the balancing unit when the sum of the voltages of the plurality of secondary battery cells is equal to or less than the first reference value at least while the plurality of secondary battery cells are being discharged or charged.

### Appendix 12

In the electric storage device according to Appendix 11, the plurality of secondary battery cells are lithium-ion batteries and the first reference value is equal to or greater than 3.4 V and equal to or less than 3.6 V.

### Appendix 13

In the electric storage device according to any one of Appendices 7 to 12, a difference in voltage between the secondary battery cell with the highest voltage and the secondary battery cell with the lowest voltage among the plurality of secondary battery cells when charging is completed is equal to or greater than 0.1 V and equal to or less than 0.5 V.

### Appendix 14

There is provided a method for operating an electric storage device including: preparing an electric storage device including a plurality of secondary battery cells which are connected in series, a measurement unit which measures the sum of voltages of the plurality of secondary battery cells, and a balancing unit which equalizes the voltages of the plurality of secondary battery cells; and operating the balancing unit when a charging rate of the plurality of secondary battery cells is equal to or less than 50% or the sum of the voltages is equal to or less than a first reference value and a differential value of a graph indicating the sum of the voltages when the charging rate is a variable is equal to or less than a second reference value.

### Appendix 15

In the method for operating the electric storage device according to Appendix 14, the balancing unit is operated at least while the plurality of secondary battery cells are being discharged or charged.

### Appendix 16

In the method for operating the electric storage device according to Appendix 14 or 15, the plurality of secondary battery cells are lithium-ion batteries and the second reference value is equal to or greater than 0.015 and equal to or less than 0.019.

### Appendix 17

In the method for operating the electric storage device according to Appendix 14 or 15, the plurality of secondary battery cells are lithium-ion batteries. The balancing unit is operated when the sum of the voltages is equal to or less than the first reference value. The first reference value is equal to or greater than 3.4 V and equal to or less than 3.6 V.

### Appendix 18

There is provided a method for operating an electric storage device including: preparing an electric storage device including a plurality of secondary battery cells which are connected in series, a measurement unit which measures the sum of voltages of the plurality of secondary battery cells, and a balancing unit which equalizes the voltages of the plurality of secondary battery cells; and operating the balancing unit when the sum of the voltages of the plurality of secondary battery cells is equal to or less than the first reference value at least while the plurality of secondary battery cells are being discharged or charged.

### Appendix 19

In the method for operating the electric storage device according to Appendix 18, the plurality of secondary battery cells are lithium-ion batteries and the first reference value is equal to or greater than 3.4 V and equal to or less than 3.6 V.

### Appendix 20

In the method for operating the electric storage device according to any one of Appendices 14 to 19, a difference in voltage between the secondary battery cell with the highest voltage and the secondary battery cell with the lowest voltage among the plurality of secondary battery cells when charging is completed is equal to or greater than 0.1 V and equal to or less than 0.5 V.

### Appendix 21

There is provided a program for controlling an electric storage device including a plurality of secondary battery cells which are connected in series, a measurement unit which measures the sum of voltages of the plurality of secondary battery cells, and a balancing unit which equalizes the voltages of the plurality of secondary battery cells. The program causes a computer to have the function of operating the balancing unit when a charging rate of the plurality of secondary battery cells is equal to or less than 50% or the sum of the voltages is equal to or less than a first reference value and a differential value of a graph indicating the sum of the voltages when the charging rate is a variable is equal to or less than a second reference value.

### Appendix 22

In the program according to Appendix 21, the balancing unit is operated at least while the plurality of secondary battery cells are being discharged or charged.

### Appendix 23

In the program according to Appendix 21 or 22, the plurality of secondary battery cells are lithium-ion batteries and the second reference value is equal to or greater than 0.015 and equal to or less than 0.019.

### Appendix 24

In the program according to Appendix 21 or 22, the plurality of secondary battery cells are lithium-ion batteries. The balancing unit is operated when the sum of the voltages is equal to or less than the first reference value. The first reference value is equal to or greater than 3.4 V and equal to or less than 3.6 V.

### Appendix 25

There is provided a program for controlling an electric storage device including a plurality of secondary battery cells which are connected in series, a measurement unit which measures the sum of voltages of the plurality of secondary battery cells, and a balancing unit which equalizes the voltages of the plurality of secondary battery cells. The program causes a computer to have the function of operating the balancing unit when the sum of the voltages of the plurality of secondary battery cells is equal to or less than the first reference value at least while the plurality of secondary battery cells are being discharged or charged.

### Appendix 26

In the program according to Appendix 25, the plurality of secondary battery cells are lithium-ion batteries and the first reference value is equal to or greater than 3.4 V and equal to or less than 3.6 V.

Priority is claimed on Japanese Patent Application No. 2012-182930, filed on Aug. 22, 2012, the content of which is incorporated herein by reference.

1. A battery control device that controls an electric storage device including a plurality of secondary battery cells which are connected in series, a measurement unit which measures the sum of voltages of the plurality of secondary battery cells, and a balancing unit which equalizes the voltages of the plurality of secondary battery cells,
wherein the balancing unit is operated when a charging rate of the plurality of secondary battery cells is equal to or less than 50% or the sum of the voltages is equal to or less than a first reference value and an absolute value of a differential value of the sum of the voltages when the charging rate is a variable is equal to or less than a second reference value.

2. The battery control device according to claim 1,
wherein the balancing unit is operated at least while the plurality of secondary battery cells are being discharged or charged.

3. The battery control device according to claim 1,
wherein the plurality of secondary battery cells are lithium-ion batteries, and
the second reference value is equal to or greater than 0.015 and equal to or less than 0.019.

4. The battery control device according to claim 1,
wherein the plurality of secondary battery cells are lithium-ion batteries,
the balancing unit is operated when the sum of the voltages is equal to or less than the first reference value, and
the first reference value is equal to or greater than 3.4 V and equal to or less than 3.6 V.

5. A battery control device that controls an electric storage device including a plurality of secondary battery cells which are connected in series, a measurement unit which measures the sum of voltages of the plurality of secondary battery cells, and a balancing unit which equalizes the voltages of the plurality of secondary battery cells,
wherein the balancing unit is operated when the sum of the voltages of the plurality of secondary battery cells is equal to or less than the first reference value at least while the plurality of secondary battery cells are being discharged or charged.

6. The battery control device according to claim 5,
wherein the plurality of secondary battery cells are lithium-ion batteries, and
the first reference value is equal to or greater than 3.4 V and equal to or less than 3.6 V.

7. An electric storage device comprising:
a plurality of secondary battery cells which are connected in series;
a measurement unit which measures the sum of voltages of the plurality of secondary battery cells;
a balancing unit which equalizes the voltages of the plurality of secondary battery cells; and
a control unit which controls the balancing unit,
wherein the control unit operates the balancing unit when a charging rate of the plurality of secondary battery cells is equal to or less than 50% or the sum of the voltages is equal to or less than a first reference value and a differential value of a graph indicating the sum of the voltages when the charging rate is a variable is equal to or less than a second reference value.

8. An electric storage device comprising:
a plurality of secondary battery cells which are connected in series;
a measurement unit which measures the sum of voltages of the plurality of secondary battery cells;
a balancing unit which equalizes the voltages of the plurality of secondary battery cells; and
a control unit which controls the balancing unit,
wherein the control unit operates the balancing unit when the sum of the voltages of the plurality of secondary battery cells is equal to or less than the first reference value at least while the plurality of secondary battery cells are being discharged or charged.

9. The electric storage device according to claim 7,
wherein the plurality of secondary battery cells are lithium-ion batteries, and
a difference in voltage between the secondary battery cell with the highest voltage and the secondary battery cell with the lowest voltage among the plurality of secondary battery cells when charging is completed is equal to or greater than 0.1 V and equal to or less than 0.5 V.

10. A method for operating an electric storage device, comprising:
preparing an electric storage device including a plurality of secondary battery cells which are connected in series, a measurement unit which measures the sum of voltages of the plurality of secondary battery cells, and a balancing unit which equalizes the voltages of the plurality of secondary battery cells; and
operating the balancing unit when a charging rate of the plurality of secondary battery cells is equal to or less than 50% or the sum of the voltages is equal to or less than a first reference value and a differential value of a graph indicating the sum of the voltages when the charging rate is a variable is equal to or less than a second reference value.

11. A method for operating an electric storage device, comprising:
preparing an electric storage device including a plurality of secondary battery cells which are connected in series, a measurement unit which measures the sum of voltages of the plurality of secondary battery cells, and a balancing unit which equalizes the voltages of the plurality of secondary battery cells; and
operating the balancing unit when the sum of the voltages of the plurality of secondary battery cells is equal to or less than the first reference value at least while the plurality of secondary battery cells are being discharged or charged.

12. A non-transitory storage medium storing a program for controlling an electric storage device including a plurality of secondary battery cells which are connected in series, a measurement unit which measures the sum of voltages of the plurality of secondary battery cells, and a balancing unit which equalizes the voltages of the plurality of secondary battery cells,
the program causing a computer to have the function of operating the balancing unit when a charging rate of the plurality of secondary battery cells is equal to or less than 50% or the sum of the voltages is equal to or less than a first reference value and a differential value of a graph indicating the sum of the voltages when the charging rate is a variable is equal to or less than a second reference value.

13. A non-transitory storage medium storing a program for controlling an electric storage device including a plurality of secondary battery cells which are connected in series, a measurement unit which measures the sum of voltages of the plurality of secondary battery cells, and a balancing unit which equalizes the voltages of the plurality of secondary battery cells,
the program causing a computer to have the function of operating the balancing unit when the sum of the voltages of the plurality of secondary battery cells is equal to or less than the first reference value at least while the plurality of secondary battery cells are being discharged or charged.
